(19) United States
(12) Patent Application Publication
(10) Pub. No.: US 2010/0010896 A1
(43) Pub. Date: Jan. 14, 2010

(54) System and Method to Deliver Advertisement Data

(75) Inventor: Dale Malik, Dunwoody, GA (US)

Correspondence Address: AT&T Legal Department - LNA;Attn: Patent Docketing, Room 2A- 207, One AT & T Way, Bedminster, NJ, 07921, US

(73) Assignee: AT&T DELAWARE INTELLECTUAL PROPERTY, INC., Wilmington, DE (US)

(21) Appl. No.: 12/172,320

(22) Filed: Jul. 14, 2008

(51) Int. Cl. G06Q 30/00

(52) U.S. Cl. 705/14.58; 705/14.1

(57) ABSTRACT

A method of delivering advertisement data includes receiving a communication from a mobile device at an advertisement data system and identifying an out-of-home venue based on contact information at which the communication is received. The method also includes sending a plurality of advertisement data options to the mobile device. The plurality of advertisement data options are associated with a plurality of advertisements presented at the out-of-home venue. The plurality of advertisements includes the contact information.

### FIELD OF THE DISCLOSURE

The present disclosure generally relates to communications networks, and more particularly relates to delivering advertisement data.

### BACKGROUND

Advertising is common outside the home. Advertisements may be presented at movie theaters, concerts, sporting events and other venues. A person may not be able to recall all advertisements presented at a venue, including advertisements in which the person is interested.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating a particular embodiment of a system to deliver advertisement data;

FIG. 2 is a block diagram illustrating a second particular embodiment of a system to deliver advertisement data;

FIG. 3 is a block diagram illustrating a third particular embodiment of a system to deliver advertisement data;

FIG. 4 is a block diagram illustrating a particular embodiment of a method of receiving advertisement data;

FIG. 5 is a block diagram illustrating a second particular embodiment of a method of receiving advertisement data;

FIG. 6 is a block diagram illustrating a particular embodiment of a method of delivering advertisement data;

FIG. 7 is a block diagram illustrating a second particular embodiment of a method of delivering advertisement data; and

FIG. 8 is a block diagram illustrating a particular embodiment of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed systems, methods or computer-readable media. Moreover, some statements may apply to some inventive features but not to others.

A method of delivering advertisement data includes receiving a communication from a mobile device at an advertisement data system. The method also includes identifying an out-of-home venue based on contact information at which the communication is received. Further, the method includes sending a plurality of advertisement data options to the mobile device. The plurality of advertisement data options are associated with a plurality of advertisements presented at the identified out-of-home venue. The plurality of advertisements includes the contact information.

In another embodiment, a method of delivering advertisement data includes receiving a communication from a mobile device at an advertisement data system, wherein the communication includes an out-of-home venue identifier. The method also includes identifying an out-of-home venue based on the out-of-home venue identifier. Further, the method includes sending a plurality of advertisement data options to the mobile device. The plurality of advertisement data options are associated with a plurality of advertisements presented at the out-of-home venue. The plurality of advertisements includes the out-of-home venue identifier.

In a further embodiment, a system to deliver advertisement data includes an advertisement data system including processing logic and memory accessible to the processing logic. The memory includes instructions executable by the processing logic to receive a communication from a mobile device at an advertisement data system and to identify an out-of-home venue based on the communication. The memory also includes instructions executable by the processing logic to send a plurality of advertisement data options to the mobile device. The plurality of advertisement data options are associated with a plurality of advertisements presented at the out-of-home venue.

In yet another embodiment, a system to receive advertisement data includes a mobile device adapted to send a communication to an advertisement data system and to receive a plurality of advertisement data options from the advertisement data system in response to the communication. The plurality of advertisement data options are associated with a plurality of advertisements presented at an out-of-home venue. Further, the mobile device is adapted to store advertisement data associated with a selected one of the plurality of advertisement data options.

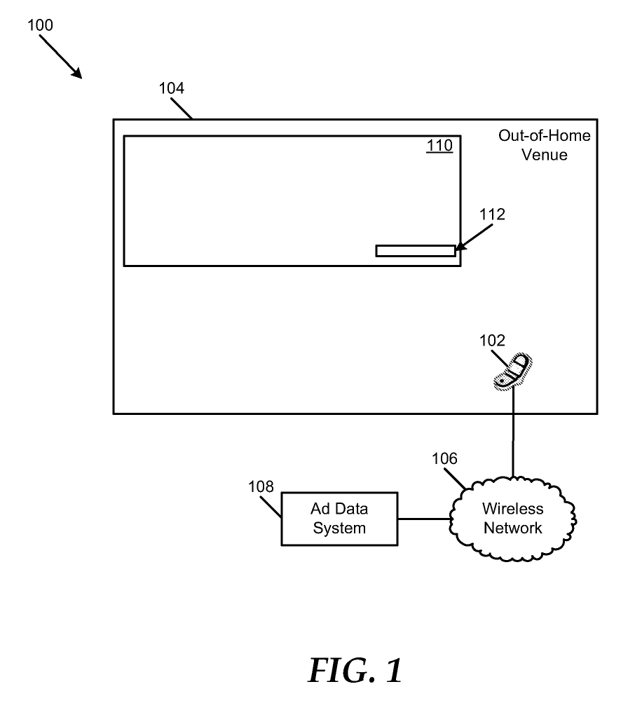

FIG. 1 illustrates a particular embodiment of a system 100 to deliver advertisement data. The system 100 includes a mobile device 102 located at an out-of-home venue 104. The out-of-home venue 104 can include, for example, a movie theater, a movie theater complex, a concert venue, a sports venue, a business conference venue, an education venue, a casino, or another out-of-home venue. The system 100 also includes an advertisement data system 108 that is adapted to communicate with mobile devices, such as the mobile device 102, via at least one wireless network 106.

In an illustrative embodiment, one or more advertisements 110 are presented at the out-of-home venue 104. The advertisement(s) 110 can be presented via a video screen, signage, audio, other methods, or any combination thereof. Each advertisement 110 can include venue-specific information 112 associated with the out-of-home venue 104. In one embodiment, the venue-specific information 112 can include contact information associated with the out-of-home venue 104 and usable to communicate with the advertisement data system 108, such as a short messaging service (SMS) number, an e-mail address, an Internet address, a phone number, a Wi-Fi contact, other contact information, or any combination thereof.

The mobile device 102 can be adapted to send a communication to the advertisement data system 108 via the contact information, in response to user input instructing the mobile device 102 to send the communication. The advertisement data system 108 is adapted to receive the communication from the mobile device 102 and to register the mobile device 102 in association with the out-of-home venue 104, a period of time (such as a movie showtime, a concert duration, or another period of time), an event, or a combination thereof. The advertisement data system 108 can be adapted to identify the out-of-home venue 104 via the contact information at which the advertisement data system 104 received the communication from the mobile device 102. In a particular embodiment, the advertisement data system 108 can be adapted to use source identification information (such as caller ID information, a sender's e-mail address, an IP address of the mobile device, etc.) received with the communication as registration information to identify the mobile device 102. In addition, the advertisement data system 108 can be adapted to send a registration acknowledgement to the mobile device 102.

The mobile device 102 is adapted to send a request for advertisement data to the advertisement data system 108. For instance, the mobile device 102 can receive input from a user indicating that the mobile device 102 is to request data related to one or more of the advertisement(s) 110 presented at the out-of-home venue 104, such as a movie trailer, a product advertisement, a service advertisement, another advertisement, or any combination thereof. The mobile device 102 can be adapted to send the request for the advertisement data to the advertisement data system 108 in response to the input.

The advertisement data system 108 is adapted to retrieve options of advertisement data associated with advertisements presented at the out-of-home venue 104, such as the advertisement 110, and to send the advertisement data options to the mobile device 102. The mobile device 102 is adapted to receive the advertisement data options from the advertisement data system 108 and to display the advertisement data options. For example, if the advertisements presented at the out-of-home venue 104 include a movie trailer, a product advertisement and a service advertisement, the advertisement data options can include showtime information related to the movie trailer, an electronic coupon for the product, and contact information related to the service provider.

The mobile device 102 is adapted to receive a selection of one or more of the advertisement data options and to send a request for the selected advertisement data to the advertisement data system 108. The advertisement data system 108 can be adapted to receive the request from the mobile device 102, and to retrieve and send the requested advertisement data to the mobile device 102.

Data related to an advertisement can include, for example, electronically readable codes, such as a bar code; an electronic asset that is usable to redeem an offer related to an advertisement, such as an electronic coupon; a mobile version of the advertisement; other data related to an advertisement; or any combination thereof. Other examples of data related to an advertisement include a date, a time, a location, terms, an identification of a product, an identification of a service, a showtime or time associated with another advertised event, other information, or any combination thereof, related to an offer or event.

In one embodiment, the mobile device 102 receives the requested advertisement data and stores the received advertisement data via an ad wallet feature. The mobile device 102 can be adapted to parse advertisement data that it receives and to identify a tag received with the advertisement data. The tag can indicate that the advertisement data is advertisement-related, can indicate one or more types of advertisement data (such as video, music, coupon, calendar information, media, etc.), can indicate other attributes of the advertisement data, or any combination thereof. Further, the mobile device 102 can be adapted to open or otherwise activate an ad wallet feature, such as an ad wallet folder, in response to identifying the tag.

The mobile device 102 is adapted to store the advertisement data in association with the ad wallet. The advertisement data can be stored in association with one or more categories, such as by a type of advertisement data, subject matter, other category, or any combination thereof. In addition, the mobile device 102 can be adapted to store a direct communication address with the advertisement data, such that a user can retrieve additional information from the advertiser. The mobile device 102 can be adapted to receive a selection of the ad wallet, such as from a graphical user interface at the mobile device 102, and to display the contents of the ad wallet. The mobile device 102 can be adapted to receive a selection of the data related to the advertisement and to display the data related to the selected advertisement.

The advertisement data system 108 can be adapted to determine whether an end time of an event at the out-of-home venue 104 has occurred. The advertisement data system 108 can be adapted to clear registrations of mobile devices associated with the out-of-home venue 104, the event, a period of time corresponding to the event, or a combination thereof, after the end time occurs. For example, after the end of a movie, the advertisement data system 108 can clear registrations of mobile devices associated with a particular theater in a complex, but not another theater whose feature has a different end time.

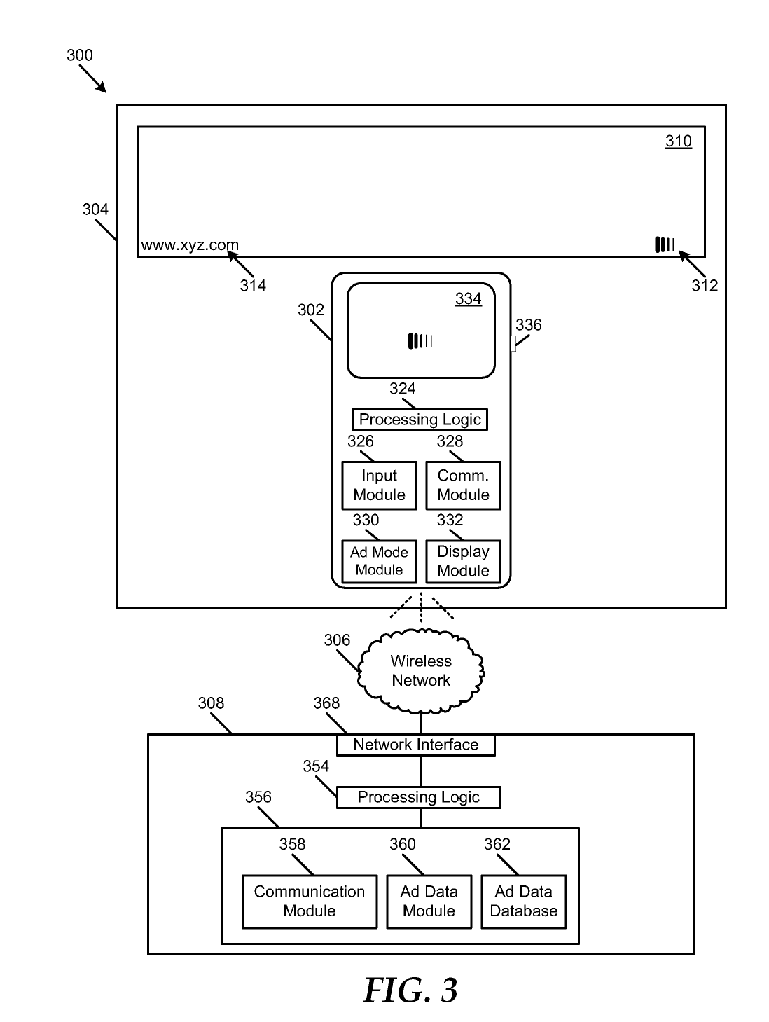

In another illustrative embodiment, the venue-specific information 112 can include a venue identifier associated with the out-of-home venue 104. The mobile device 102 can be adapted to photograph the out-of-home venue identifier and to send a communication to the advertisement data system 108 that includes the photograph of the out-of-home venue identifier. The advertisement data system 108 can be adapted to receive a communication that includes the photograph of the out-of-home venue identifier from the mobile device 102 and to identify the out-of-home venue 104 based on the out-of-home venue identifier. An example of an out-of-home venue identifier is illustrated in FIG. 3.

The advertisement data system 108 is also adapted to retrieve advertisement data options associated with the out-of-home venue 104 and to send the advertisement data options to the mobile device 102. The advertisement data options can also be associated with a period of time, an event, or a combination thereof. The mobile device 102 can be adapted to receive the advertisement data options from the advertisement data system 108. The mobile device 102 can be adapted to receive a selection of one or more of the advertisement data options and to request advertisement data corresponding to the selected option from the advertisement data system 108.

Alternatively, the advertisement data system 108 can be adapted to send advertisement data related to each advertisement presented at the out-of-home venue 104 to the mobile device 102 in response to the communication received from the mobile device 102. The mobile device 102 can be adapted to receive a selection of one or more of the advertisement data options and to store the selected advertisement data via an ad wallet feature at the mobile device 102. The mobile device 102 can be adapted to delete or otherwise discard advertisement data that is not selected.

The system 100 can implement functions related to delivering advertisement data utilizing one or more communication methods. In one example, the mobile device 102 can be adapted to send a communication via SMS including a request to register the mobile device 102 with the advertisement data system 108. The advertisement data system 108 can be adapted to receive the communication via an SMS number that has been assigned to a particular sports arena during a particular sporting event. The advertisement data system 108 can be adapted to register the mobile device 102 in association with the sports arena, the sporting event, a period of time during which the sporting event is to take place, or any combination thereof, and to send an SMS registration acknowledgement to the mobile device 102. Further, the mobile device 102 can be adapted to send a request for advertisement data to the advertisement data system 108, and the advertisement data system 108 can be adapted to send advertisement data options, selected advertisement data, other communications, or any combination thereof, to the mobile device 102 via SMS.

In another example, the mobile device 102 can be adapted to place a voice call over a mobile voice network to the advertisement data system 108 via a phone number associated with the venue, in response to user input. The advertisement data system 108 can be adapted to output an automated message to the mobile device 102 indicating that the mobile device 102 has been registered. In another embodiment, the advertisement data system 108 can be adapted to prompt the user to select one or more registration options, such as one of a plurality of venues, one of a plurality of events, one of a plurality of registration periods, or any combination thereof. The advertisement data system 108 can be adapted to send an SMS message or other instruction to the mobile device 102 to activate an advertisement data mode at the mobile device 102. Further, the mobile device 102 can be adapted to send a request for advertisement data to the advertisement data system 108, and the advertisement data system 108 can be adapted to send advertisement data options, selected advertisement data, other communications, or any combination thereof, to the mobile device 102 via SMS.

In yet another example, the mobile device 102 can be adapted to scan a Wi-Fi environment at a movie theater complex or other venue for the advertisement data system 108, in response to activation of an advertisement data mode at the mobile device 102, and to send a registration communication to the advertisement data system 108. The advertisement data system 108 can be adapted to identify the particular theater based on contact information used to send the communication, a range of the mobile device 102 from the advertisement data system 108, other methods, or a combination thereof. Further, the advertisement data system 108 can register the mobile device 102 in association with a particular feature, a showtime, or a combination thereof. In addition, the mobile device 102 can be adapted to send a request for advertisement data to the advertisement data system 108, and the advertisement data system 108 can be adapted to send advertisement data options, selected advertisement data, other communications, or any combination thereof, to the mobile device 102 via Wi-Fi.

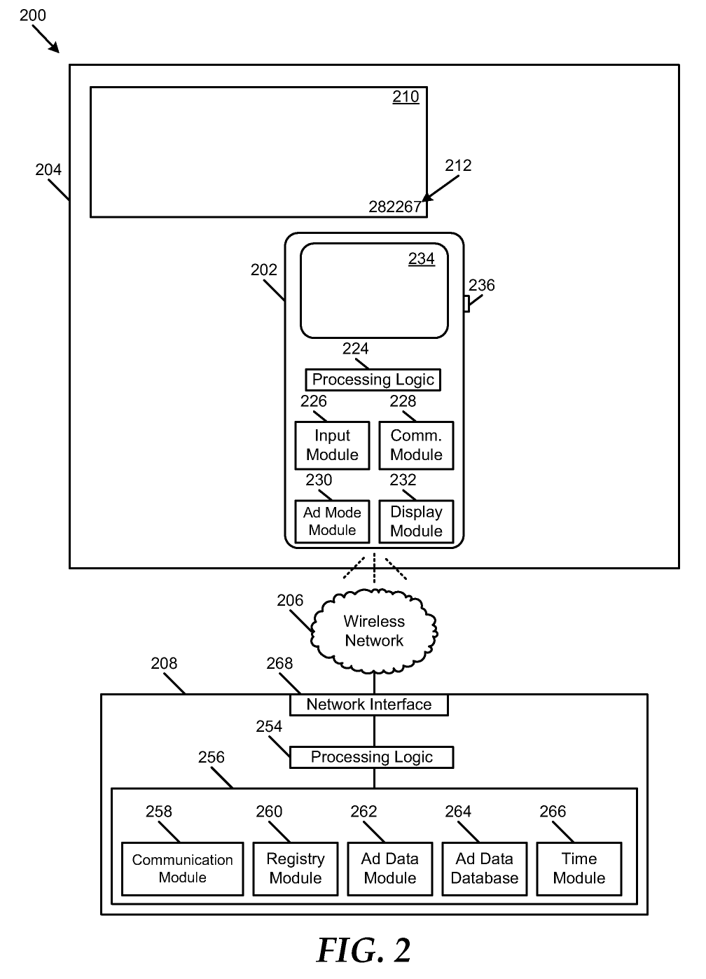

FIG. 2 illustrates a second particular embodiment 200 of a system to deliver advertisement data. The system 200 includes a mobile device 202 located at an out-of-home venue 204. The system 200 also includes an advertisement data system 208 that is adapted to communicate with mobile devices, such as the mobile device 202, via at least one wireless network 206. In an illustrative embodiment, one or more advertisements can be displayed via a video screen 210 at the out-of-home venue 204. Contact information 212 associated with the out-of-home venue 204 and usable to communicate with the advertisement data system 208 can be presented with each advertisement or before a group of advertisements. In other embodiments, advertisements can be presented via signage, audio, other methods, or any combination thereof.

The mobile device 202 includes processing logic 224 and a plurality of modules 226-232 accessible to the processing logic 224. The mobile device 202 also includes a display screen 234. The mobile device 202 can include a cellular telephone, a personal data assistant, a mobile computing device, a digital music player adapted to communicate with a wireless network, another mobile device, or any combination thereof. The plurality of modules 226-232 can include instructions executable by the processing logic 224 to perform functions of the mobile device 202 with respect to receiving advertisement data. Alternatively, the modules 226-232 can include hardware logic, computer instructions, or a combination thereof.

In a particular embodiment, the mobile device 202 includes an input module 226 that is executable by the processing logic 224 to receive user input instructing the mobile device 202 to send a communication to the advertisement data system 208 via the contact information 212, such as an SMS communication, a voice call, a Wi-Fi communication, an e-mail, or another communication. The communication can include a request to register the mobile device 202 with the advertisement data system 208. In addition, the input module 226 is executable by the processing logic 224 to receive input from a user indicating that the mobile device 202 is to request data related to one or more advertisements presented at the out-of-home venue 204, such as a movie trailer, a product advertisement, a service advertisement, another advertisement, or any combination thereof.

The mobile device 202 includes a communication module 228 that is executable by the processing logic 224 to send the communication including the registration request to the advertisement data system 208 using the contact information 212. Further, the communication module 228 is executable by the processing logic 224 to send a request for advertisement data to the advertisement data system 208 in response to user input. The communication module 228 is also executable by the processing logic 224 to receive advertisement data options from the advertisement data system 208 in response to the request.

The input module 226 can be executable by the processing logic 224 to receive a selection of one or more of the advertisement data options, and the communication module 228 can be executable by the processing logic 224 to send a request for the advertisement data corresponding to the selected option to the advertisement data system 208. The communication module 228 can be executable by the processing logic 224 to receive the selected advertisement data, which can be stored via an ad wallet feature provided via the ad mode module 230.

In one embodiment, the communication module 228 can be executable by the processing logic 204 to parse advertisement data that it receives and to identify a tag received with the advertisement data. The tag can indicate that the advertisement data is advertisement-related, can indicate one or more types of advertisement data (such as video, music, coupon, calendar information, media, etc.), can indicate other attributes of the communication module 228 can be executable by the processing logic 204 to open or otherwise activate an ad wallet feature in response to identifying the tag.

Alternatively, the communication module 228 can be executable by the processing logic 224 to receive advertisement data associated with each advertisement presented at the out-of-home venue 204. The input module 226 can be executable by the processing logic 224 to receive a selection of one or more of the advertisement data options, and the selected advertisement data can be stored via the ad wallet feature. Non-selected advertisement data can be deleted or otherwise discarded.

The mobile device 202 also includes an ad mode module 230 that is executable by the processing logic 224 to activate an advertisement data mode at the mobile device 202 in response to input from a user or the advertisement data system 208. For example, the advertisement data system 208 can send an SMS message or other instruction to the mobile device 202 to activate the advertisement data mode after the mobile device 102 is registered with the advertisement data system 208. In another example, user input can activate the advertisement data mode, and the ad mode module 230 can be executable by the processing logic 224 to search for and communicate with the advertisement data system 208 via a Wi-Fi environment, SMS or another communication method.

In a particular embodiment, the ad mode module 230 can be adapted to store advertisement data received at the mobile device 202 via an ad wallet feature. The advertisement data can be stored in association with one or more categories, such as by a type of advertisement data, subject matter, other category, or any combination thereof. In addition, a direct communication address, other data, or a combination thereof can be stored with the advertisement data.

The input module 226 is executable by the processing logic 224 to receive a command to display advertisement data stored via the ad wallet. For example, the mobile device 202 can include an assignable hot key 236 that is selectable to instruct the mobile device 202 to display contents of the ad wallet feature at the mobile device 202. The display module 232 is executable by the processing logic 224 to display the contents of the ad wallet, such as via a graphical menu. The input module 226 is executable by the processing logic 224 to receive a selection of particular advertisement data, such as an electronic coupon or other advertisement data, and the display module 232 is executable by the processing logic 224 to display the selected advertisement data via the display screen 234.

The advertisement data system 208 includes processing logic 254 and memory 256 accessible to the processing logic 254. The advertisement data system 208 can include a single server or a server system in which the processing logic 254, the memory 256, or a combination thereof, is distributed among multiple servers. The advertisement data system 208 includes a network interface 268 adapted to facilitate communication between the advertisement data system 208 and the at least one wireless network 206. Further, the memory 256 includes a plurality of modules 258-266 accessible to the processing logic 254. The plurality of modules 258-266 can include instructions executable by the processing logic 254 to perform functions of the advertisement data system 208 with respect to delivering advertisement data. Alternatively, the modules 258-266 can include hardware logic, computer instructions, or a combination thereof.

In a particular embodiment, the memory 256 includes a communication module 258 that is executable by the processing logic 254 to receive a communication that includes a registration request from the mobile device 202 and to identify the out-of-home venue 204 based on the contact information 212 at which the communication is received. The memory 256 includes a registry module 260 that is executable by the processing logic 254 to register the mobile device 202 in association with the out-of-home venue 204, a period of time, an event, or a combination thereof. In a particular embodiment, the registry module 260 can be executable by the processing logic 254 to use source identification information (such as caller ID information, a sender's e-mail address, an IP address of the mobile device, etc.) received with the communication as registration information to identify the mobile device 202. In addition, the registry module 260 can be executable by the processing logic 254 to send a registration acknowledgement to the mobile device 202. Further, the registry module 260 can be executable by the processing logic 254 to send an instruction to the mobile device 202 to activate an advertisement data mode at the mobile device 202 after the mobile device 202 has been registered with the advertisement data system 208.

The memory 256 includes an ad data module 262 that is executable by the processing logic 254 to retrieve advertisement data options associated with the out-of-home venue 204, a period of time, an event at the out-of-home venue 204, or any combination thereof, from an ad data database 264. The communication module 258 is executable by the processing logic 254 to send the advertisement data options to the mobile device 202. In addition, the communication module 258 can be executable by the processing logic 254 to receive a selection of an option from the mobile device 202. The ad data module 262 can be executable by the processing logic 254 to retrieve advertisement data corresponding to the selected option, and the communication module 258 can be executable by the processing logic 254 to send the advertisement data to the mobile device 202.

Alternatively, the ad data module 262 can be executable by the processing logic 254 to retrieve advertisement data corresponding to each advertisement presented at the out-of-home venue 204 in response to the communication received from the mobile device 202, and the communication module 258 can be executable by the processing logic 254 to send the advertisement data to the mobile device 202.

In a particular embodiment, the memory 256 can include a time module 266 that is executable by the processing logic 254 to determine whether an end time of an event at the out-of-home venue 204 has occurred. The registry module 260 can be executable by the processing logic to clear registrations of mobile devices associated with the out-of-home venue 204, the event, a period of time corresponding to the event, or a combination thereof, after the end time occurs.

FIG. 3 illustrates a third particular embodiment 300 of a system to deliver advertisement data. The system 300 includes a mobile device 302 located at an out-of-home venue 304. The system 300 also includes an advertisement data system 308 that is adapted to communicate with mobile devices, such as the mobile device 302, via at least one wireless network 306. In an illustrative embodiment, one or more advertisements can be displayed via a video screen 310 at the out-of-home venue 304. A venue identifier 312, such as a bar code or other identifier, can be presented at the out-of-home venue 304, such as with each advertisement or before a group of advertisements. Additionally, an Internet address or other contact information 314 can be presented at the out-of-home venue 304. In other embodiments, advertisements can be presented via signage, audio, other methods, or any combination thereof.

The mobile device 302 includes processing logic 324 and a plurality of modules 326-332 accessible to the processing logic 324. The mobile device 302 also includes a display screen 334. The plurality of modules 326-332 can include instructions executable by the processing logic 324 to perform functions of the mobile device 302 with respect to receiving advertisement data. Alternatively, the modules 326-332 can include hardware logic, computer instructions, or a combination thereof.

In a particular embodiment, the mobile device 302 includes an input module 326 that is executable by the processing logic 324 to photograph the out-of-home venue identifier 312 in response to a user command. The input module 326 is also executable by the processing logic 324 to receive a user command to send a communication including the photograph to the advertisement data system 308 via the contact information 314.

The mobile device 302 includes a communication module 328 that is executable by the processing logic 324 to send the communication to the advertisement data system 308 via the contact information 314. The communication module 328 is also executable by the processing logic 324 to receive advertisement data options from the advertisement data system 308 in response to the communication. Further, the input module 326 can be executable by the processing logic 324 to receive a selection of one or more of the advertisement data options, and the communication module 328 can be executable by the processing logic 324 to send a request for the selected advertisement data to the advertisement data system 308. The communication module 328 can be executable by the processing logic 324 to receive the selected advertisement data, which can be stored via an ad wallet feature provided via the ad mode module 330.

In one embodiment, the communication module 328 can be executable by the processing logic 304 to parse advertisement data that it receives and to identify a tag received with the advertisement data. The tag can indicate that the advertisement data is advertisement-related, can indicate one or more types of advertisement data (such as video, music, coupon, calendar information, media, etc.), can indicate other attributes of the communication module 328 can be executable by the processing logic 304 to open or otherwise activate an ad wallet feature in response to identifying the tag.

Alternatively, the communication module 328 can be executable by the processing logic 324 to receive advertisement data associated with each advertisement presented at the out-of-home venue 304. The input module 326 can be executable by the processing logic 324 to receive a selection of one or more of the advertisement data options, and the selected advertisement data can be stored via the ad wallet feature.

The mobile device 302 also includes an ad mode module 330 that is executable by the processing logic 324 to activate an advertisement data mode at the mobile device 302 in response to input from a user or the advertisement data system 308. For example, user input can activate the advertisement data mode prior to photographing the venue identifier 312. The ad mode module 330 can be executable by the processing logic 324 to decode the venue identifier 312 and to initialize communication with the advertisement data system 308.

In a particular embodiment, the ad mode module 330 can be adapted to store advertisement data received at the mobile device 302 via an ad wallet feature. The advertisement data can be stored in association with one or more categories, such as by a type of advertisement data, subject matter, other category, or any combination thereof. In addition, a direct communication address, other data, or a combination thereof can be stored with the advertisement data.

The input module 326 is executable by the processing logic 324 to receive a command to display advertisement data stored via the ad wallet. For example, the mobile device 302 can include an assignable hot key 336 that is selectable to instruct the mobile device 302 to display contents of the ad wallet. The display module 332 is executable by the processing logic 324 to display the contents of the ad wallet, such as via a graphical menu. The input module 326 is executable by the processing logic 324 to receive a selection of particular advertisement data, such as an electronic coupon or other advertisement data, and the display module 332 is executable by the processing logic 324 to display the selected advertisement data via the display screen 334.

The advertisement data system 308 includes processing logic 354 and memory 356 accessible to the processing logic 354. The advertisement system 308 can include a single server or a server system in which the processing logic 354, the memory 356, or a combination thereof, is distributed among multiple servers. The advertisement system 308 includes a network interface 368 adapted to facilitate communication between the advertisement data system 308 and the at least one wireless network 306. Further, the memory 356 includes a plurality of modules 358-362 accessible to the processing logic 354. The plurality of modules 358-362 can include instructions executable by the processing logic 354 to perform functions of the advertisement data system 308 with respect to delivering advertisement data. Alternatively, the modules 358-362 can include hardware logic, computer instructions, or a combination thereof.

In a particular embodiment, the memory 356 includes a communication module 358 that is executable by the processing logic 354 to receive a communication that includes the photograph of the out-of-home venue identifier 312 from the mobile device 302 and to identify the out-of-home venue 304 based on the out-of-home venue identifier 312. The memory 356 includes an ad data module 360 that is executable by the processing logic 354 to retrieve advertisement data options associated with the out-of-home venue 304 from an ad data database 362. The communication module 358 is executable by the processing logic 354 to send the advertisement data options to the mobile device 302.

In addition, the communication module 358 can be executable by the processing logic 354 to receive a selection of an option from the mobile device 302. The ad data module 360 can be executable by the processing logic 354 to retrieve advertisement data corresponding to the selected option, and the communication module 358 can be executable by the processing logic 354 to send the advertisement data to the mobile device 302. Alternatively, the ad data module 360 can be executable by the processing logic 354 to retrieve advertisement data corresponding to each advertisement presented at the out-of-home venue 304 in response to the communication received from the mobile device 302, and the communication module 358 can be executable by the processing logic 354 to send the advertisement data to the mobile device 302.

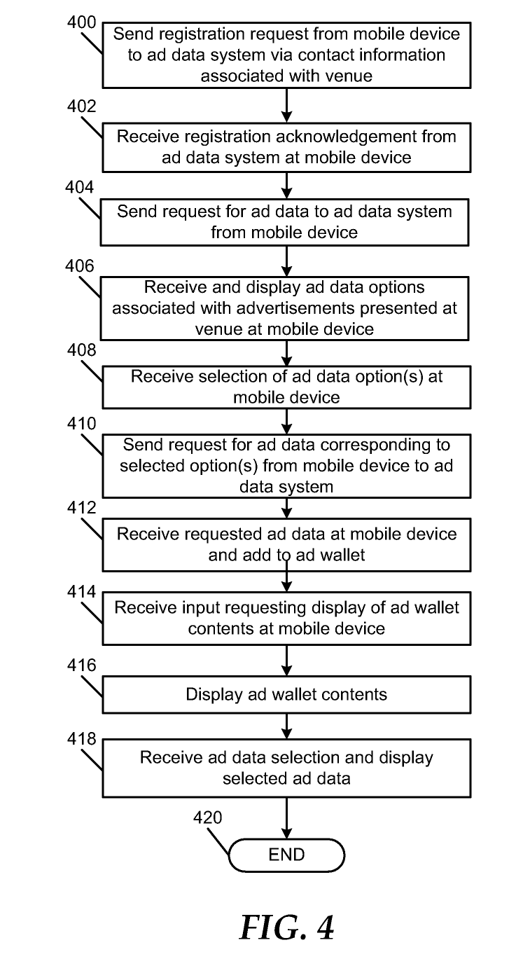

FIG. 4 shows a particular embodiment of a method of receiving advertisement data. At block 400, a mobile device sends a communication that includes a registration request to an advertisement data system. In one embodiment, the mobile device can send the communication using contact information associated with an out-of-home venue. For example, the mobile device can be a cellular telephone that sends a registration request to the advertisement data system via a short messaging service (SMS) number displayed at the out-of-home venue. In another embodiment, the mobile device can send the registration request to the advertisement data system via a Wi-Fi communication or a voice call.

Moving to block 402, in a particular embodiment, the mobile device can receive a registration acknowledgement from the advertisement data system. Proceeding to block 404, the mobile device sends a request for advertisement data to the advertisement data system. For instance, the mobile device can receive input from a user indicating that the mobile device is to request data related to one or more advertisements presented at the out-of-home venue, such as a movie trailer, a product advertisement, a service advertisement, another advertisement, or any combination thereof The mobile device can send the request for the advertisement data to the advertisement data system in response to the input.

Continuing to block 406, the mobile device receives from the advertisement data system a plurality of advertisement data options associated with a plurality of advertisements presented at the out-of-home venue. For example, if the advertisements presented at the out-of-home venue include a movie trailer, a product advertisement and a service advertisement, the advertisement data options can include showtime information related to the movie trailer, an electronic coupon for the product, and contact information related to a service provider. Advancing to block 408, the mobile device receives a selection of one or more of the advertisement data options.

At block 410, the mobile device sends a request for the selected advertisement data to the advertisement data system. Moving to block 412, the mobile device receives the requested advertisement data and stores the received advertisement data via an ad wallet feature at the mobile device. Proceeding to block 414, the mobile device can receive input requesting that contents of the ad wallet be displayed. For example, the mobile device can detect a selection of an assignable hot key, a graphical element or other input mechanism associated with the ad wallet feature. Continuing to block 416, the mobile device can display a graphical menu of the ad wallet contents. Advancing to block 418, the mobile device can receive a selection of particular advertisement data, such as an electronic coupon, via the menu and can display the selected advertisement data. The method terminates at 420.

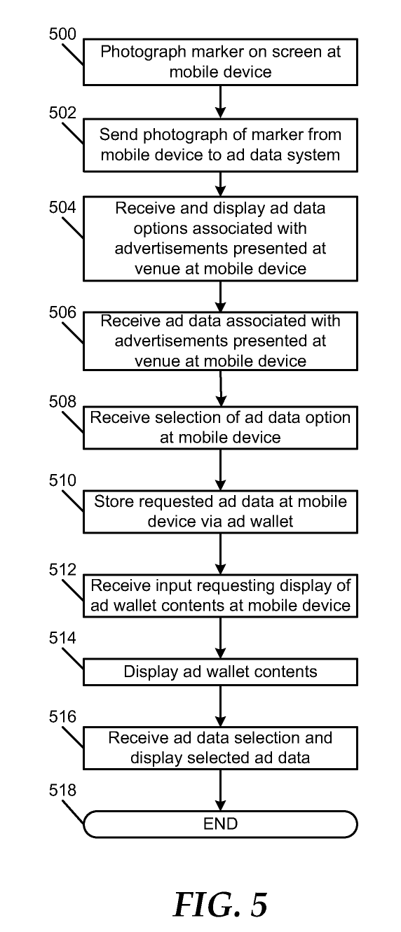

FIG. 5 illustrates a second particular embodiment of a method of receiving advertisement data. At block 500, a mobile device photographs an out-of-home venue identifier, such as an out-of-home venue marker, presented at an out-of-home venue, such as a movie theater, a movie theater complex, a concert venue, a sports venue, a business conferencing venue, a casino, or another out-of-home venue. The out-of-home venue identifier can be displayed via a video screen, such as a movie screen, signage, other visual or graphical method, or any combination thereof. In some embodiments, an advertisement data mode can be activated at the mobile device prior to the photograph.

Moving to block 502, the mobile device sends a communication to an advertisement data system that includes the photograph of the out-of-home venue identifier. In one embodiment, the mobile device can send the communication via the Internet. For instance, a web address can be presented with the out-of-home venue identifier, and a user can manipulate the mobile device to send the communication to the advertisement data system via the web address. In other embodiments, the mobile device can send the communication to the advertisement data system via SMS, e-mail or other methods.

Proceeding to block 504, the mobile device receives from the advertisement data system a plurality of advertisement data options associated with a plurality of advertisements presented at the out-of-home venue. Continuing to block 506, the mobile device receives advertisement data associated with each of the plurality of advertisements. Advancing to block 508, the mobile device receives a selection of one or more of the advertisement data options. At block 510, the mobile device stores the selected advertisement data via an ad wallet feature. The mobile device can delete or otherwise discard advertisement data that is not selected.

Moving to block 512, the mobile device can receive input requesting that contents of the ad wallet be displayed. For example, the mobile device can detect a selection of an assignable hot key, a graphical element or other input mechanism associated with the ad wallet feature. Proceeding to block 514, the mobile device can display a graphical menu of the ad wallet contents. Continuing to block 516, the mobile device can receive a selection of particular advertisement data, such as an electronic coupon, via the menu and can display the selected advertisement data. The method terminates at 518.

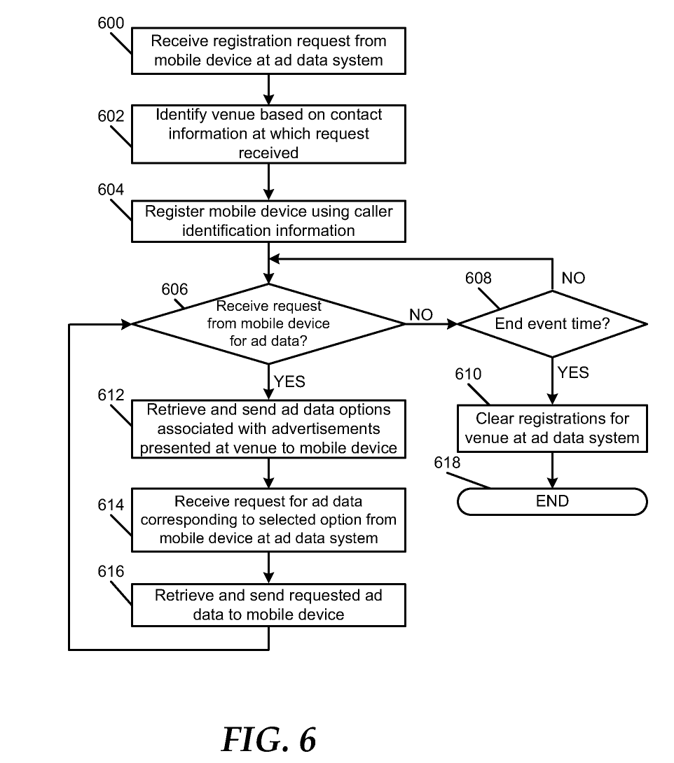

FIG. 6 illustrates a particular embodiment of a method of delivering advertisement data. At block 600, an advertisement data system receives a registration request from a mobile device at an out-of-home venue. Moving to block 602, in a particular embodiment, the advertisement data system can identify the out-of-home venue based on contact information at which the registration request is received. For example, the advertisement data system can receive the registration request via an SMS number associated with the out-of-home venue and can identify the venue based on the SMS number. In another embodiment, the advertisement data system can be local to the out-of-home venue and can receive the registration request via a Wi-Fi network. For instance, the out-of-home venue can be a movie theater, and the registration request can be received via a Wi-Fi network at a movie theater complex.

Proceeding to block 604, the advertisement data system registers the mobile device. In an illustrative embodiment, the advertisement data system can use caller identification information to register the mobile device, such as a phone number, user name, other information, or any combination thereof. In some embodiments, the advertisement data system can send a registration acknowledgement, an instruction to activate an advertisement data mode, or a combination thereof, to the mobile device after registration.

Continuing to decision node 606, the advertisement data system determines whether it has received a request from a registered mobile device for advertisement data associated with advertisements presented at the out-of-home venue. If the advertisement data system determines that it has not received a request for advertisement data, the method advances to decision node 608, and the advertisement data system determines whether an end time of an event at the out-of-home venue has occurred. If the end time has not occurred, the method returns to decision node 606. If the end time has occurred, the method moves to block 610, and the advertisement data system clears registrations of mobile devices associated with the out-of-home venue, the event, or a combination thereof. For example, at the end of a movie, the advertisement data system can clear registrations of mobile devices associated with a particular theater in a complex, but not another theater whose feature has a different end time.

Returning to decision node 606, if the advertisement data system has received a request from a registered mobile device for advertisement data, the method proceeds to block 612. At block 612, the advertisement data system retrieves options of advertisement data associated with advertisements presented at the out-of-home venue and sends the advertisement data options to the requesting mobile device. Continuing to block 614, the advertisement data system receives a request from the mobile device for advertisement data corresponding to a selected advertisement data option. Advancing to block 616, the advertisement data system retrieves and sends the requested advertisement data to the mobile device. The method can then return to decision node 606. The method terminates at 618.

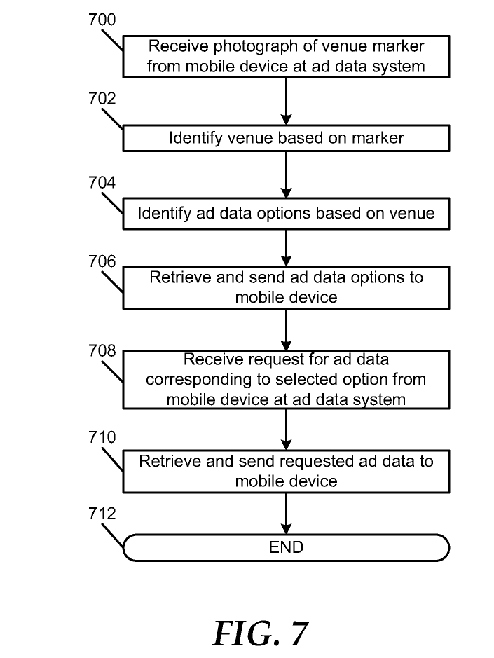

FIG. 7 illustrates a second particular embodiment of a method of delivering advertisement data. At block 700, an advertisement data system receives a communication that includes a photograph of a venue marker or other venue identifier from a mobile device at an out-of-home venue. Moving to block 702, the advertisement data system identifies the out-of-home venue based on the venue marker. Proceeding to block 704, the advertisement data system identifies advertisement data options associated with the out-of-home venue. The advertisement data options can also be associated with a period of time, an event, or a combination thereof.

Continuing to block 706, the advertisement data system retrieves options of advertisement data associated with advertisements presented at the out-of-home venue and sends the advertisement data to the requesting mobile device. Advancing to block 708, the advertisement data system receives a request from the mobile device for advertisement data corresponding to a selected advertisement data option. Advancing to block 710, the advertisement data system retrieves and sends the requested advertisement data to the mobile device. In other embodiments, the advertisement data system can send advertisement data associated with each of the advertisements presented at the out-of-home venue to the mobile device in response to the communication, such that the advertisement data system does not receive a request for advertisement data associated with a selected option. The method terminates at 712.

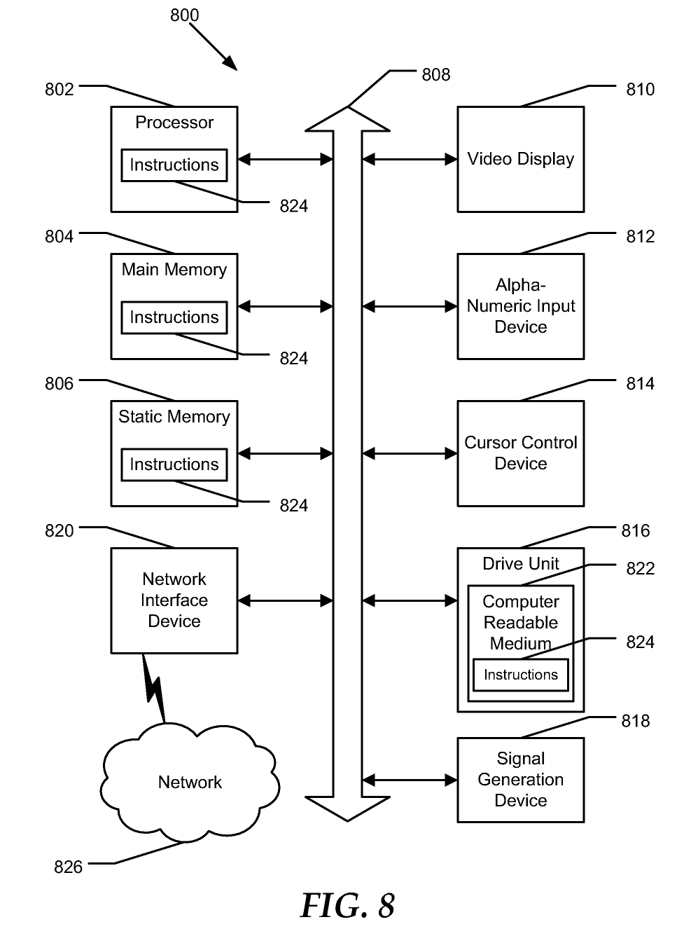

FIG. 8 shows an illustrative embodiment of a general computer system 800 including a set of instructions that can be executed to cause the computer system to perform any one or more of the methods or computer based functions disclosed herein. The computer system 800 may operate as a standalone device or may be connected, such as using a network, to other computer systems or peripheral devices. In an illustrative embodiment, such standalone and peripheral devices can include, for example, ad data systems, mobile devices, servers, other network elements, or any combination thereof, as illustrated in FIGS. 1-3.

In a networked deployment, the computer system may operate in the capacity of a server or as a client user computer in a server-client user network environment, or as a peer computer system in a peer-to-peer (or distributed) network environment. The computer system 800 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

The computer system 800 may include a processor 802, such as a central processing unit (CPU), a graphics processing unit (GPU), or both. Moreover, the computer system 800 can include a main memory 804 and a static memory 806 that can communicate with each other via a bus 808. As shown, the computer system 800 may further include a video display unit 810, such as a liquid crystal display (LCD), an organic light emitting diode (OLED), a flat panel display, a solid state display, or a cathode ray tube (CRT). Additionally, the computer system 800 may include an input device 812, such as a keyboard, and a cursor control device 814, such as a mouse. The computer system 800 can also include a disk drive unit 816, a signal generation device 818, such as a speaker or remote control, and a network interface device 820.

In a particular embodiment as depicted in FIG. 8, the disk drive unit 816 may include a computer-readable medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable media. The network interface device 820 can provide connectivity to a network 826, such as a wide area network (WAN), a local area network (LAN), or other network.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 824 or receives and executes instructions 824 responsive to a propagated signal, so that a device connected to a network 826 can communicate voice, video or data over the network 826. Further, the instructions 824 may be transmitted or received over the network 826 via the network interface device 820.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (such as TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A method of delivering advertisement data, the method comprising:
receiving a communication from a mobile device at an advertisement data system;
identifying an out-of-home venue based on contact information at which the communication is received; and
sending a plurality of advertisement data options to the mobile device, wherein the plurality of advertisement data options are associated with a plurality of advertisements presented at the identified out-of-home venue and wherein the plurality of advertisements includes the contact information.

2. The method of claim 1, wherein the communication includes a registration request and wherein the method further comprises registering the mobile device at the advertisement data system.

3. The method of claim 2, further comprising eliminating registration information at the advertisement data system after an end time of an event at the out-of-home venue occurs.

4. The method of claim 3, wherein the plurality of advertisements are associated with the event.

5. The method of claim 1, further comprising sending an instruction to the mobile device to activate an advertisement data mode at the mobile device.

6. The method of claim 1, further comprising receiving a request for advertisement data from the mobile device, wherein the plurality of advertisement data options are sent in response to the request for advertisement data.

7. The method of claim 1, further comprising:
receiving data from the mobile device indicating a selection of one of the plurality of advertisement data options; and
sending advertisement data associated with the selected advertisement data option to the mobile device.

8. A method of delivering advertisement data, the method comprising:
receiving a communication from a mobile device at an advertisement data system, wherein the communication includes an out-of-home venue identifier;
identifying an out-of-home venue based on the out-of-home venue identifier; and
sending a plurality of advertisement data options to the mobile device, wherein the plurality of advertisement data options are associated with a plurality of advertisements presented at the out-of-home venue and wherein the plurality of advertisements includes the out-of-home venue identifier.

9. The method of claim 8, wherein the communication includes a photograph of the out-of-home venue identifier.

10. The method of claim 8, further comprising identifying the advertisement data options associated with the out-of-home venue.

11. The method of claim 8, further comprising sending advertisement data associated with each of the plurality of advertisement data options to the mobile device.

12. The method of claim 8, further comprising:
receiving data from the mobile device indicating a selection of one of the plurality of advertisement data options; and
sending advertisement data associated with the selected advertisement data option to the mobile device.

13. A system to deliver advertisement data, the system comprising:
an advertisement data system including processing logic and memory accessible to the processing logic, wherein the memory includes instructions executable by the processing logic to:
receive a communication from a mobile device at an advertisement data system;
identify an out-of-home venue based on the communication; and
send a plurality of advertisement data options to the mobile device, wherein the plurality of advertisement data options are associated with a plurality of advertisements presented at the out-of-home venue.

14. The system of claim 13, wherein the communication includes an out-of-home venue identifier.

15. The system of claim 14, wherein the communication includes a request to register the mobile device with the out-of-home venue for a period of time.

16. The system of claim 13, wherein the out-of-home venue is a movie theater, a movie theater complex, a concert venue, a sports venue, a business conference venue, a casino, or an educational venue.

17. The system of claim 14, further comprising a network interface adapted to communicate with the mobile device via short messaging service (SMS), e-mail, Wi-Fi, Internet, a mobile voice network, or any combination thereof.

18. The system of claim 17, further comprising a database to store advertisement data associated with the plurality of advertisements, wherein the advertisement data includes an electronic coupon, an electronically readable code, a mobile version of an advertisement, information related to an offer associated with the advertisement, information related to an event associated with the advertisement, service provider information, or any combination thereof.

19. A system to receive advertisement data, the system comprising:
a mobile device adapted to:
send a communication to an advertisement data system;
receive a plurality of advertisement data options from the advertisement data system in response to the communication, wherein the plurality of advertisement data options are associated with a plurality of advertisements presented at an out-of-home venue; and
store advertisement data associated with a selected one of the plurality of advertisement data options.

20. The system of claim 19, wherein the communication includes a registration request.

21. The system of claim 19, wherein the communication includes a photograph of an out-of-home venue identifier.

22. The system of claim 19, wherein the mobile device is adapted to:
activate an advertisement mode in response to user input;
search for the advertisement data system within a Wi-Fi environment; and
send the communication via the Wi-Fi environment.

23. The system of claim 19, wherein the mobile device is adapted to:
graphically display the advertisement data options;
receive input indicating the selected one of the plurality of advertisement data options;
send data indicating the selected one of the plurality of advertisement data options to the advertisement data option; and
receive the advertisement data associated with the selected one of the plurality of advertisement data options from the advertisement data system.

24. The system of claim 19, wherein the mobile device is adapted to store the advertisement data associated with the selected one of the plurality of advertisement data options via an ad wallet feature at the mobile device.

25. The system of claim 24, wherein the mobile device is adapted to:
display a graphical menu of contents of the ad wallet feature in response to a selection of an assignable hot key at the mobile device;
receive a selection of the advertisement data associated with the selected one of the plurality of advertisement data options via the graphical menu; and
display the advertisement data associated with the selected one of the plurality of advertisement data options.
